(19) United States
(12) Patent Application Publication
(10) Pub. No.: US 2004/0111643 A1
(43) Pub. Date: Jun. 10, 2004

(54) System and method for providing an enterprise-based computer security policy

(76) Inventor: Daniel G. Farmer, San Francisco, CA (US)

Correspondence Address: MOSER, PATTERSON & SHERIDAN, LLP, Suite 100, 595 Shrewsbury Avenue, Shrewsbury, NJ, 07702-4185, US

(21) Appl. No.: 10/726,466

(22) Filed: Dec. 2, 2003

Related U.S. Application Data
(60) Provisional application No. 60/430,170, filed on Dec. 2, 2002.

(51) Int. Cl. H04L 9/00

(52) U.S. Cl. 713/201; 713/166

(57) ABSTRACT

A system and method for providing an enterprise-based security policy are described. In one embodiment, the system includes a central agent that is configured to retrieve a policy skin from a database and to transmit the policy skin to a host. The system further includes a data gathering engine that is configured to collect host data related to the host. In addition, the system includes a policy engine that is configured to execute the policy skin against the host data to determine security policy compliance.

### CROSS-REFERENCE TO RELATED APPLICATION(S)

This application relates to, and claims the priority benefit of, U.S. Provisional Patent Application No. 60/430,170, titled “Information-Based, Policy-Driven Network Security Systems and Methods,” filed Dec. 2, 2002. The subject matter of this related application is hereby incorporated by reference.

### FIELD OF THE INVENTION

The present invention generally relates to computer security and more specifically to a system and method for providing an enterprise-based computer security policy.

### BACKGROUND

As businesses, educational institutions and government entities (each an example of an “enterprise”) increase their use of computers and computer networks, and the sophistication and frequency of attacks on computer networks increases (e.g., the Nimbda worm and the “I Love You” E-mail virus), computer security becomes an increasingly important issue. To combat such attacks as well as other computer security problems, such as unauthorized computer and data access, network administrators typically attempt to develop enterprise-wide security policies and then employ various types of computer security hardware and software to implement those security policies.

One drawback to this approach is that standard computer security hardware and software usually are not designed to address the multitude of security threats to a computer network. Network administrators are therefore forced to buy different pieces of hardware and software to address different aspects of a given enterprise-based security policy. This piece-meal approach to computer security oftentimes results in a system with security holes, leaving the computer network vulnerable to attack. Further, this approach makes tracking overall security policy compliance extremely difficult, if not impossible. These problems are exacerbated as the size of the enterprise increases.

Another drawback is that computer security hardware and software oftentimes are designed for technically savvy persons, requiring some knowledge of computer hardware or programming languages to implement the computer security hardware or software properly. Such requirements not only limit the number of persons within an enterprise who can plan, develop and implement a computer security policy, but also limit the functionality that can be built into the computer security hardware and software.

Yet another drawback is that most computer security hardware and software, with the exception of anti-virus software, are not tailored to address the specific security threats to each of the different hosts of a given computer network. As the individual hosts are the weakest link in the computer network—the elements of the network most susceptible to break-ins and other security breaches—not adequately protecting each of the individual hosts also compromises the security of the computer network itself.

### SUMMARY

One embodiment of a system for providing an enterprise-based security policy includes a central agent that is configured to retrieve a policy skin from a database and to transmit the policy skin to a host. The system further includes a data gathering engine that is configured to collect host data related to the host. In addition, the system includes a policy engine that is configured to execute the policy skin against the host data to determine security policy compliance.

One advantage of the disclosed system is that the combination of policy skins and groups enables a user to develop and implement a comprehensive security policy configured to address the specific security needs of all of the different areas of a given enterprise. Another advantage is that policy skins are created using policy strings, which enable users to write security policies in a human-readable format. This capability allows a wide range of users with varying degrees of technical training to create and implement security policies using the disclosed system as individual users do not need to understand the computer code or other syntax underlying the security policies. In addition, policy skins are specially designed for and implemented on the individual machines of a computer network. Policy skins therefore enable an enterprise-based security policy to be tailored to address the specific threats to the individual hosts of an enterprise's computer network. The disclosed system thus focuses security policy compliance and enforcement at the host level—the part of the computer network most susceptible to security threats as most activity occurs on the individual hosts—thereby resulting in an overall more secure system. Yet another advantage is that the disclosed system provides up-to-date reports setting forth, among other things, the aggregate level of security policy compliance across an enterprise's computer network. These reports, among other things, allow users such as network administrators to understand and to track security policy compliance at each individual machine. This information may be used, for example, to identify and to fix security shortfalls throughout an enterprise's computer network to create an overall more secure system.

### BRIEF DESCRIPTION OF THE DRAWINGS

FIG. 1 is a block diagram illustrating a computer network configured to implement an enterprise-based security system, according to one embodiment of the invention;

FIG. 2 is a block diagram illustrating a conceptual configuration of the central server and one of the hosts of FIG. 1, according to one embodiment of the invention;

FIG. 3 is a conceptual diagram illustrating the architecture of a language stack, according to one embodiment of the invention;

FIG. 4 is a conceptual diagram illustrating a policy skin, according to one embodiment of the invention;

FIG. 5 is a conceptual diagram illustrating a set of groups, according to one embodiment of the invention;

FIG. 6 is a conceptual diagram illustrating various features of the enterprise-based security system, according to one embodiment of the invention; and

FIG. 7 is a flow chart of method steps for providing an enterprise-based security policy, according to one embodiment of the invention.

### DETAILED DESCRIPTION

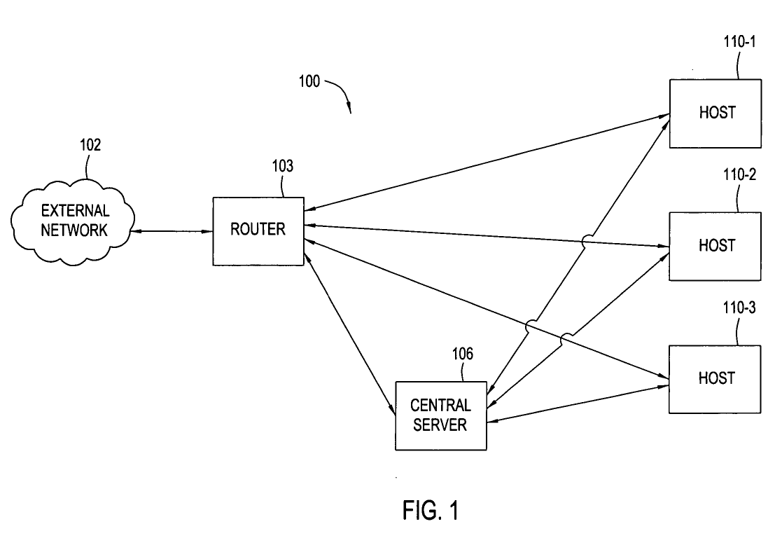

FIG. 1 is a block diagram illustrating a computer network 100 configured to implement an enterprise-based security policy, according to one embodiment of the invention. As shown, computer network 100 is coupled to an external network 102 using a network device such as a router 103. External network 102 may be any type of data network, including, without limitation, a local area network (LAN), a metropolitan area network (MAN), a wide area network (WAN) or the Internet.

FIG. 1 also shows that computer network 100 may include, without limitation, hosts 110-1, 110-2 and 110-3 (also referred to as “hosts 110”) and a central server 106. Each of hosts 110-1, 110-2 and 110-3 may be any type of individual computing device such as, for example, a server machine, a desk-top computer, a lap-top computer, a set-top box, game system or console or a personal digital assistant.

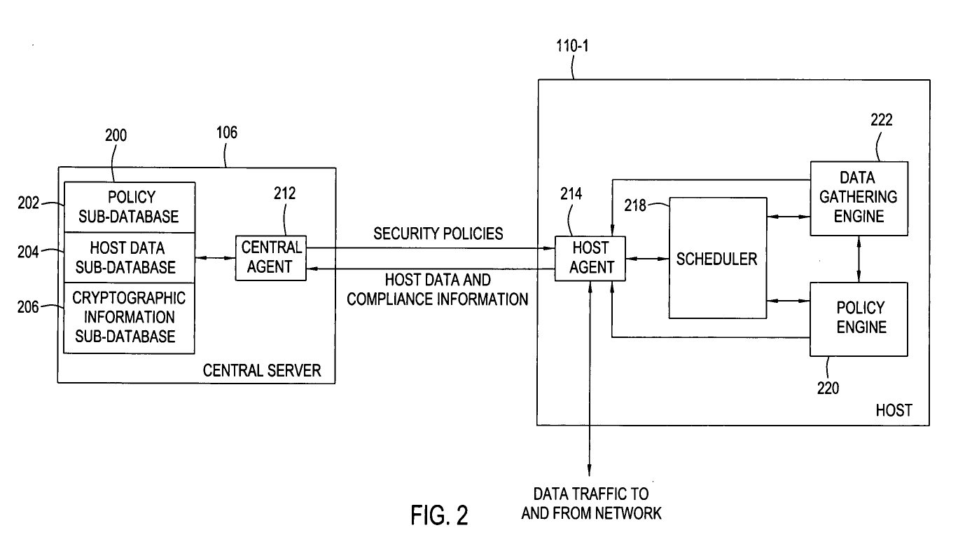

As described in further detail below in conjunction with FIG. 2, central server 106 is configured to administer an enterprise-based computer security policy over computer network 100. More specifically, central server 106 is configured to store individual security policies in an internal database (not shown)-the compilation of these individual security policies constitutes the enterprise-based security policy. Each individual security policy may be specifically tailored to be implemented on one or more of hosts 110. Central server 106 is further configured to transmit (or “push down”) to each of hosts 110-1, 110-2 and 110-3 each individual security policy specifically tailored for that host. Hosts 110 are, in turn, configured to implement the individual policies received from central server 106. As is described in further detail herein, the result is an enterprise-based security policy that is configured to guard against specific security threats encountered at the host level. The disclosed system thereby provides a more effective enterprise-based security policy than current systems, which typically are not configured to enforce security policies on the individual hosts, where most activity occurs.

In the embodiment set forth in FIG. 1, computer network 100 represents an enterprise-based computer network. Persons skilled in the art, however, will recognize that computer network 100 may have any technically feasible configuration. For example, in alternative embodiments, computer network 100 may include any number and/or type of hosts 110. In other alternative embodiments, computer network 100 may include two or more central servers 106. Persons skilled in the art will therefore understand that the configuration of computer system 100 in no way limits the scope of the present invention.

FIG. 2 is a block diagram illustrating a conceptual configuration of central server 106 and one of hosts 110 of FIG. 1, according to one embodiment of the invention. As persons skilled in the art will understand, each of hosts 110-1, 110-2 and 110-3 has the same general configuration. For this reason, the configuration of only host 110-1 is described herein.

As is described in further detail below, central server 106 is configured to transmit one or more individual security policies to host 110-1, which is configured to execute each such security policy. Host 110-1 is further configured to collect data about itself and its user(s) (referred to as “host data”) and to use this data to determine whether it is in compliance with the one or more individual security policies. In addition, host 110-1 is configured to transmit the host data and information pertaining to its state of compliance with the one or more security policies to central server 106. A user of the disclosed system may then analyze this host data and compliance information to understand whether host 110-1 is in compliance with the enterprise-based security policy as well as why host 110-1 is or is not in compliance. Further, the user may aggregate the host data and compliance information transmitted to central server 106 for all hosts 110 of computer network 100 to understand the global state of compliance with the enterprise-based security policy.

As shown, central server 106 may include, without limitation, a database 200 and a central agent 212. Database 200 may include one or more sub-databases to store specific types of operational information relevant to administering the enterprise-based security policy. As shown, database 200 includes, without limitation, a policy sub-database 202, a host data sub-database 204 and a cryptographic information sub-database 208. Policy sub-database 202 is configured to store any type of security policy information. Such information may include, without limitation, the library of policy rules available for creating individual security policies and individual security policies that have been created.

Host data sub-database 204 is configured to store the host data transmitted to central server 106 by the various hosts 110. Host data may include, without limitation, user information, such as password and user name information, network information, such as incoming and outgoing data packet count and port use information, host configuration information, such as host operating system information and installed hardware and software information, file system information, such as file names and sizes, and information about currently running applications, such as user account information, network port(s) information and information pertaining to associated files and libraries. Host data sub-database 204 is further configured to store security policy compliance information transmitted by the various hosts 110 (e.g., whether host 110-1 is in compliance with the one or more security policies being implemented on host 110-1).

Cryptographic information sub-database 208 is configured to store any information pertaining to encrypting any of the data traffic transmitted over computer network 100, including both data traffic transmitted internally to computer network 100 and data traffic transmitted to external network 102.

In one embodiment, database 200 (as well as individual sub-databases 202, 204, 206 and 208) comprises an Structured Query Language (“SQL”) accessible database such as those provided by MySQL, Oracle or IBM. In alternative embodiments, however, database 200 may comprise any type of database. In addition, in alternative embodiments, one or more of sub-databases 202, 204, 206 and 208 may comprise an individual database, separate and distinct from database 200, or each of sub-databases 202, 204, 206 and 208 may comprise a separate and distinct database.

Central agent 212 manages all communications with each of hosts 110. More specifically, central agent 212 is configured to monitor and receive all data traffic transmitted to central server 106 by any of hosts 110 and to transmit that data as necessary to the different sub-databases of database 200. Such data traffic includes, without limitation, host data and all security policy compliance information, including any messages (or alarms or warnings) indicating a breach of security policy. Central agent 212 is further configured to retrieve the individual security policies stored in policy sub-database 202 of database 200 and, in one embodiment, to transmit or push down the executable versions of those security policies to various hosts 110.

Central server 106 also includes a user interface (not shown) that allows users to access and to interact with central server 106. In one embodiment, the user interface comprises a web-based interface.

As also shown in FIG. 2, host 110-1 may include, without limitation, a host agent 214, a scheduler 218, a policy engine 220 and a data gathering engine 222. Host agent 214 manages all communications with central agent 212. More specifically, host agent 214 is configured to receive the individual security policies transmitted to host 110-1 by central agent 212 and to transmit host data and security policy compliance information back to central agent 212, as described in further detail below. Host agent 214 may be further configured to control policy engine 220 and data gathering engine 222, via scheduler 218, and to arbitrate potential conflicts among the various communication and processing operations of host 110-1.

Scheduler 218 is configured to initiate at regular time intervals a specified cycle of activities for host 110-1. Data gathering engine 222 is configured to collect host data pertaining to host 110-1 and to transmit that information to policy engine 220 and host agent 214. Policy engine 220 is configured to receive the host data from data gathering engine 222 and to retrieve the executable versions of the one or more individual security policies transmitted to host 110-1 from central server 106. Policy engine 220 is further configured to read each individual security policy, to compare the various policy rules of each individual security policy with the host data collected from host 110-1 and to determine whether host 110-1 is in compliance with each individual security policy. Policy engine 220 also is configured to initiate any enforcement actions specified in a given individual security policy to the extent that host 110-1 is not in compliance with that particular individual security policy. Enforcement actions may include, without limitation, taking actions to put host 110-1 back into compliance with the individual security policy, sending a message to central server 106 that host 110-1 is not in compliance with the individual security policy and taking any arbitrary actions that the individual security policy may specify should be taken when host 110-1 is not in compliance. Finally, policy engine 220 is configured to transmit to host agent 214 the state of compliance of host 110-1 for each individual security policy.

In one embodiment, the cycle of activities that scheduler 218 initiates for host 110-1 includes, without limitation, data gathering activities, policy analysis and enforcement activities and reporting activities. First, scheduler 218 initiates the data gathering activities. During the allotted time period, data gathering engine 222 collects the host data pertaining to host 110-1. Next, scheduler 218 initiates the policy analysis and enforcement activities. During the allotted time period, data gathering engine transmits the collected host data to policy engine 222, and policy engine 220 retrieves the executable versions of the one or more individual security policies transmitted to host 110-1 from central server 106. Policy engine 220 then reads each individual security policy, compares the various policy rules of each individual security policy with the host data, determines whether host 110-1 is in compliance with each individual security policy and, to the extent that host 110-1 is not in compliance with a particular individual security policy, initiates any enforcement actions specified in that individual security policy. Finally, scheduler 218 initiates the reporting activities. During the allotted time period, data gathering agent 222 transmits the collected host data to host agent 214, and policy engine 220 transmits to host agent 214 the state of compliance of host 110-1 for each individual security policy. Host agent 214 then transmits the host data and the security policy compliance information to central agent 212 of central server 106.

In addition to the foregoing, in one embodiment, a packet filter is placed in the network layer of host 110-1 to enable accessing, modifying, recording and controlling all data traffic in and out of host 110-1. Persons skilled in the art will recognize that by placing such a packet filter on each of hosts 110 in computer network 100, all data traffic on computer network 100 may be accessed, modified and controlled.

As persons skilled in the art will understand, on an aggregate level, all hosts 110 of computer network 100 may be configured to run through the cycle of activities described herein at regular time intervals on an ongoing basis. In such a configuration, all hosts 110 may report host data and security policy compliance information to central server 106 simultaneously. To ensure proper synchronization of these activities, as well as proper coordination of other system and network activities, central server 106 and each of hosts 110 may run the Network Time Protocol service (or other equivalent protocol).

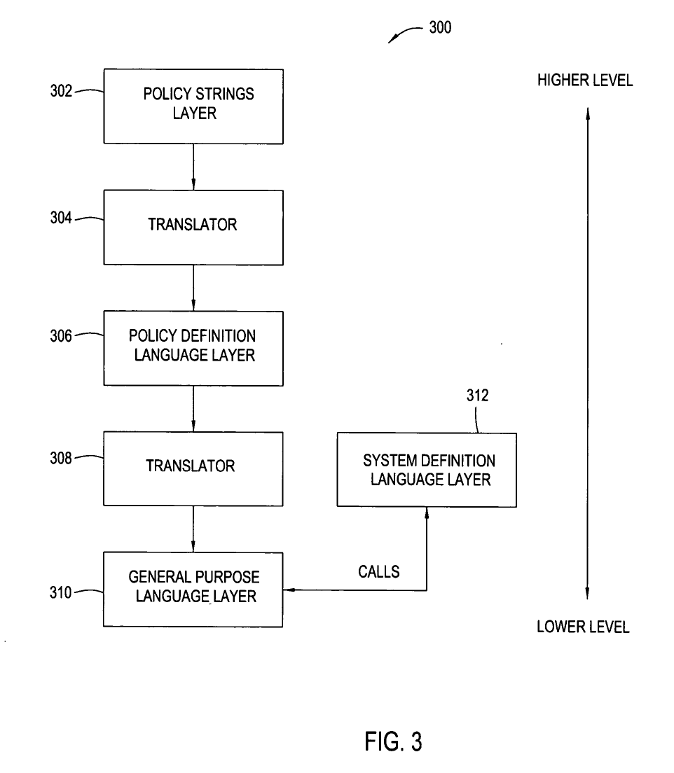

FIG. 3 is a conceptual diagram illustrating the architecture of a language stack 300, according to one embodiment of the invention. As shown, language stack 300 includes, without limitation, a policy strings layer 302, a translator 304, a policy definition language (“PDL”) layer 306, a translator 308, a general purpose language layer 310 and a system definition language (“SDL”) layer 312.

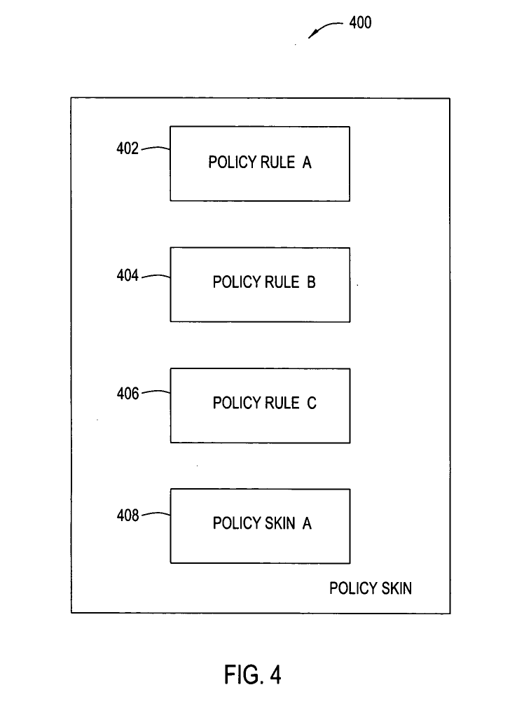

Policy strings layer 302 comprises the policy strings (also referred to as “policy rules”) that are used to create the individual security policies that central server 106 transmits to various hosts 110. A given policy string may be configured statically to express a fixed policy rule. A given policy string also may be configured to include one or more variables or parameters that may be defined to modify or to focus the behavior of the policy rule expressed by that policy string. In this manner, a policy string may be configured with functionality similar to that of a macro. As indicated in FIG. 3, the policy strings constitute the highest level language in language stack 300. Importantly, each policy string is written in human-readable form to enable users of the disclosed system to create specific, well-defined security policies for each of hosts 110 with minimal effort. As described in further detail below in conjunction with FIG. 4, in one embodiment, the versions of the individual security policies that reside in policy sub-database 202 are written in policy strings (each such version also referred to as the “policy string version” of the individual security policy).

PDL layer 306 comprises the PDL (also referred to as “Fuel”), which is the middle-tier language in language stack 300. As persons skilled in the art will understand, the PDL constitutes a special purpose little language that comprises a well-defined set of grammars that are specially tailored towards computer security (i.e., security policy creation and enforcement). Among other things, the PDL is structured such that its various grammars may be translated easily into a general purpose language.

General purpose language layer 310 comprises a general purpose language. As indicated in FIG. 3, the general purpose language is the lowest level language in language stack 300. In one embodiment, the general purpose language comprises the Python language. In alternative embodiments, however, the general purpose language may comprise any general purpose language.

Translator 304 is configured to parse the various policy strings that comprise a given security policy into the PDL, and translator 308 is configured to parse the PDL into the general purpose language. As persons skilled in the art will understand and as described above in conjunction with FIG. 2, the executable versions of the security policies that various hosts 110 execute are written in the general purpose language. Thus, in the embodiment of FIG. 2, for each security policy that central server 106 transmits to one or more hosts 110, translators 304 and 308 first parse each of the policy strings of the policy string version of that security policy (which, in that embodiment, resides in policy sub-database 202) into the general purpose language. This process produces the executable version of that security policy. Central agent 212 of central server 106 then transmits the security policy (i.e., the executable version of the security policy) to one or more hosts 110.

SDL layer 312 comprises the SDL, which includes all of the run-time libraries and support services necessary to execute the various security policies on various hosts 110. When policy engine 220 of one of hosts 110 executes a security policy transmitted by central server 106, certain instructions contained in the executable version of that security policy configure policy engine 220 to make calls to the SDL to access the various functions of the run-time libraries and/or support services needed to execute the security policy. Notable, the SDL includes a separate set of run-time libraries and support services for each operating system (also referred to as a “platform” or “deployment”) run on one or more of hosts 110. As described in further detail herein, the instructions contained in each executable version of a security policy designate which set of run-time libraries and support services policy engine 220 of a particular one of hosts 110 should call based on the specific platform type of that particular one of hosts 110. As persons skilled in the art will recognize, this functionality enables language stack 300 to be implemented across any and all types of host operating systems. In this manner, SDL layer 312 has functionality similar to that of an application programming interface.

As persons skilled in the art will understand, the disclosed architecture enables a policy string (or group of policy strings) to be configured to implement any type of policy rule or related enforcement action. For each such policy string (or group of policy strings), the PDL and the SDL should be configured to implement the functionality of the policy rule or enforcement action underlying the policy string (or group of policy strings). In addition, translator 304 should be configured to parse the policy string (or group of policy strings) into the grammars (i.e., the PDL code) that implement the functionality of the policy rule or enforcement action underlying the policy string (or group of policy strings).

In one embodiment, such as the embodiment of FIG. 2, translator 304 resides in central server 106. In such an embodiment, central server 106 may be configured to determine the platform type of each of hosts 110 of computer network 100 to which central agent 212 transmits a particular security policy (the group of hosts 110 receiving the particular security policy referred to as “receiving hosts 110”). Central server 106 may be further configured to communicate this information to translator 304, which is configured to parse the policy strings of the policy string version of that security policy (which resides in policy sub-database 202) into different versions of the PDL. Each such version of the PDL corresponds to one of the platform types of receiving hosts 110 and includes instructions designating the set of run-time libraries and support services in the SDL that should be accessed for that particular platform type. Translator 308 then parses these different versions of the PDL into the general purpose language to create different executable versions of the security policy—one version for each of the different platform types of receiving hosts 110. Central agent 212 may be configured to transmit the executable version of the security policy corresponding to a given platform type to each one of receiving hosts 110 running that particular platform type. In this manner, each one of receiving hosts 110 receives an executable version of the security policy that includes. instructions for calling the run-time libraries and support services in the SDL corresponding to the specific platform type of that one of receiving hosts 110.

For example, in the context of FIG. 2, central server 106 may be configured to determine the operating system running on host 110-1 (Linux for purposes of this example). Central server 106 may be further configured to communicate to translator 304 that host 110-1 runs on Linux. For a particular security policy that central server 106 transmits to host 110-1, translator 304 parses the policy strings of the policy string version of that security policy (stored in policy sub-database 202) into the PDL. This PDL version of the security policy includes instructions for calling the run-time libraries and support services of the SDL that are configured for the Linux operating system. Translator 308 then parses the PDL version of the security policy into the general purpose language to create an executable version of the security policy. This executable version, which central agent 212 transmits to host 110-1, also includes instructions for calling the run-time libraries and support services of the SDL that are configured for the Linux operating system.

In an alternative embodiment, translator 304 may reside on each of hosts 110 in computer system 100, and each of hosts 110 may be configured to communicate its platform type to translator 304. In such an embodiment, central agent 212 transmits the policy string version of the security policy (which resides in policy sub-database 202) to each of receiving hosts 110. For each such receiving host 110, translator 304 is configured to parse the policy strings of the policy string version of the security policy into a version of the PDL corresponding to the platform type of the particular receiving host 100. As described herein, this version of the PDL includes instructions designating the set of run-time libraries and support services in the SDL that should be accessed for that particular platform type. Again, when translator 308 parses the PDL version of the security policy into the general purpose language, the executable version of the security policy also will include instructions for calling the run-time libraries and support services in the SDL corresponding to the specific platform type of that receiving host 110.

For example, in the context of FIG. 2, translator 304 may reside in host 110-1, and host 110-1 may be configured to communicate to translator 304 the type of operating system running on host 110-1 (again, Linux for purposes of this example). Further, central agent 212 may be configured to transmit a policy string version of a security policy (stored in policy sub-database 202) to host 110-1. Translator 304 parses the policy strings of the policy string version into the PDL. This PDL version of the security policy includes instructions for calling the run-time libraries and support services of the SDL that are configured for the Linux operating system. Translator 308 then parses the PDL version of the security policy into the general purpose language to create an executable version of the security policy. This executable version, which policy engine 220 executes, also includes instructions for calling the run-time libraries and support services of the SDL that are configured for the Linux operating system.

In yet another alternative embodiment, a user may determine the platform type of each of receiving hosts 110 and enter this information into central server 106 (e.g., by using the web-based user interface). As described herein, central server 106 may be configured to communicate this information to translator 304, which resides in central server 106. Again, translator 304 may be configured to parse the policy strings of the policy string version of the security policy (stored in policy sub-database 202) to create different PDL versions of the security policy—one PDL version for each of the different platform types of receiving hosts 110. Translator 308 may configured to parse each version of PDL into the general purpose language to create an executable version of the security policy for each of the different platform types of receiving hosts 110. Finally, central agent 212 may configured to transmit the executable version of the security policy corresponding to a given platform type to each one of receiving hosts 110 running that particular platform type.

Language stack 300 enables very complicated computer code underlying an enterprise-based security policy to be abstracted to a high-level, human-readable format. Conversely, language stack 300 enables a complicated enterprise-based security policy to be written in a high-level, human-readable format and then translated into computer code that can be executed on the individual machines of an enterprise-wide computer network. As described in further detail below in conjunction with FIG. 4, the disclosed architecture creates a flexible, user-friendly way of designing enterprise-based security policies. Notably, the fact the disclosed architecture allows users to write security policies in a human-readable format makes the disclosed system accessible to a wide range of users since an individual user does not need to understand the underlying computer-oriented languages (e.g., the PDL and the general purpose language) to create an enforceable security policy. Rather, a user utilizes the policy strings, which may be structured in plain English (or any other language), to create the individual security policies that comprise the enterprise-based security policy. A wide variety of people of different technical levels therefore may use the disclosed system.

FIG. 4 is a conceptual diagram illustrating a policy skin 400, according to one embodiment of the invention. As shown, policy skin 400 may include, without limitation, a policy rule A 402, a policy rule B 404, a policy rule C 406 and a policy skin A 408. Each of policy rule A 402, policy rule B 404 and policy rule C 406 comprises one or more policy strings, and policy skin A 408 comprises one or more policy rules. In alternative embodiments, policy skin 400 may comprise any number of policy rules and/or any number of policy skins. Each policy skin may constitute an individual security policy that central server 106 transmits to one or more hosts 110 of computer network 100. The compilation of these policy skins comprises the enterprise-based security policy for the enterprise represented by computer network 100.

One of the advantages of the disclosed system is the flexibility and ease of creating policy skins (i.e., individual security policies) using policy strings and other policy skins. As described above in conjunction with FIG. 3, a given policy string (or group of policy strings) may be configured to implement any type of policy rule or enforcement action. Typical policy rules or enforcement actions include, without limitation, allowing or disallowing certain actions to occur, denying access to various network resources, implementing various firewall functionalities on hosts 110 and logging and recording various actions that occur on hosts 110. For example, if a user wants to implement a policy rule that causes one or more hosts 110 to run a virus or malware checker on all incoming files, the user can write a policy string that states, “run Norton Utilities on all incoming files,” into policy skin 400. This policy string may be designated as policy rule A 402. If the user wants to regulate how accountants and engineers in the given enterprise interact with one another over computer network 100, the user can write a policy string that states, “engineers cannot talk to accountants over the network except via E-mail; log any violations,” into policy skin 400. This policy string may be designated as policy rule B 404. If the user wants to ensure that all data traffic transmitted from one or more of hosts 110 is encrypted, the user can write a policy string that states, “encrypt all outgoing network traffic,” into policy skin 400. This policy string may be designated as policy rule C 406. If the user wants to disable all file system sharing over computer network 100, the user can write a policy string that states, “disable all file system sharing capabilities,” into policy skin 400.

Time-oriented regulations also may be implemented in policy skin 400 using policy strings. For example, if a user wants to limit the amount of time or the hours during which the users of certain hosts 110 can access the web server, the user can write a policy string that states, “the individual machine may access the web server for only two hours per day” or “the individual machine may access the web server only between 11:00 am and 2:00 pm each day” into policy skin 400.

Other policy rules or enforcement actions that policy strings may be configured to implement include, without limitation, the following: blocking network packets based on Internet Protocol (“IP”) addresses, disabling a network account with no password, detecting a version of a program (using meta-data, MD5 signatures and the like), blocking user access to sensitive files or programs, reducing data traffic to and/or from a particular individual machine by a certain percentage, reducing peer-to-peer data traffic by a certain percentage, not allowing any program other than a web browser to access an external network, encrypting all email while leaving all other data traffic untouched, preventing communications to any individual machine that has an irresolvable IP address, logging all emails sent by all vice presidents of an enterprise to catch a high-level security leak, searching all outgoing email for the phrase, “company confidential,” and sending an alarm if such an email is found, filtering email for viruses, tracking who is logged into the network, recording who the owners are of the various individual machines in the network, accounting for all hardware and software on the network and tracking the ongoing use of that hardware and software, minimizing the number of constantly running applications on any individual machine, removing or disabling applications not necessary for routine individual machine operations and ensuring that security bugs are patched and/or reported.

In addition to the foregoing, policy strings may be configured to specify whether enforcement actions should or should not be taken when a policy rule violation occurs on a given host 110. For example, a policy string may be configured to implement an enforcement actions whereby a given host 110 should only notify central server 106 when a policy rule violation occurs, without taking any specific enforcement action. When policy skin 400 includes policy strings of this effect, each of hosts 110 implementing policy skin 400 is deemed to be in “read only” mode. By contrast, when policy skin 400 includes a policy string specifying that certain enforcement actions should take place when a policy rule violation occurs, each of hosts 110 implementing policy skin 400 is deemed to be in “enforcement” mode. In enforcement mode, a policy string may be configured to implement, for example, enforcement actions that (i) put offending host 110 back into compliance, (ii) give the user of offending host 110 a certain amount of time, such as a week, to put offending host 110 back into compliance or face further enforcement action by central server 106 or (iii) provide the user of offending host 10 with instructions for putting offending host 10 back into compliance.

As persons skilled in the art will understand, the basic problems of computer security are relatively well understood. For this reason, a finite number of policy strings may be designed to address many known computer security threats. (These policy strings also may be written in any language.) Further, new policy strings may be developed fairly easily to address each new computer security threat that arises. The disclosed system therefore may be used to create policy skins that address virtually any computer security threat that may exist for a particular computer network 100. In addition, an enterprise implementing the disclosed system does not have to create its own policy skins. Rather, a third party expert in computer security (or any other third party) may design policy skins for any enterprise using a finite set of policy strings, so long as the third party knows which security policy or enforcement action each policy string in the finite set has been configured to implement. In such instances, central server 106 may be configured to implement these third-party policy skins; the third party only needs to transmit those policy skins to central server 106.

Policy skins are transferable, meaning that a policy skin being implemented on a first host 10 may be implemented on a second host 10. Once the policy skin has been implemented on the second host 10, the behavior of second host 10 (in the context of the enterprise-based security policy) will mirror that of the first host 10. In addition, multiple policy skins may be implemented on one or more of hosts 110. To the extent that these different policy skins contain conflicting policy rules, the policy rules themselves may be configured to resolve the conflicts. For example, in one embodiment, the policy rules may be configured such that each of hosts 110 that receives conflicting policy rules implements the policy rule in the highest priority policy skin.

Policy skins also may be used to create predefined security policies that may be implemented on specific types of hosts 110. For example, a user may design a set of policy skins where each policy skin in the set has a different level of security, privacy or network monitoring. The user then may implement the different policy skins on certain types of hosts 110 as the user's security needs dictate. For example, a user may want the individual machine of every vice president in the enterprise to implement a specific set of policy rules and enforcement actions. The user can design a predefined policy skin called “Vice Presidents” using the policy strings that implement the desired set of policy rules and enforcement actions. The user then can implement the “Vice Presidents” policy skin on the individual machine of every vice president in the enterprise and/or every new vice president that joins the enterprise.

Policy skins also may be created for “red alert” situations. These special policy skins may include high security policy rules that are to be implemented on certain designated hosts 110 in a crisis or emergency situation. For example, each such policy skin may designate one or more hosts 110 to which the policy skin should be transmitted in the event of a crisis or emergency. Central server 106 may be configured with a built-in crisis level indicator that triggers in the event of a crisis or emergency. Central server 106 may be further configured to transmit each special policy skin automatically to one or more specifically designated hosts 110 upon the crisis level indicator's triggering. Alternatively, a third party may be responsible for transmitting an alarm or other alert to central server 106 in a crisis or emergency situation. Central server 106 may be configured to transmit each special policy skin automatically to one or more specifically designated hosts 110 upon receiving the third-party alarm or other alert.

Yet another feature of policy skins is that they may be dynamically linked, meaning that a policy skin implemented on a first host 110 may be configured to mirror one or more policy skins implemented on a second host 110. For example, suppose policy skin A implemented on first host 110 is configured to mirror policy skin B implemented on second host 110. First host 110 and second host 110 may be configured to communicate with one another periodically to compare policy skin A and policy skin B. First host 110 may be further configured to modify policy skin A to reflect any changes made to policy skin B. Thus, in a situation where policy rule C is added to policy skin B, first host 110 detects this change to policy skin B and then automatically updates policy skin A to include policy rule C. First host 110 then begins to adhere to policy rule C as does second host 110. In one embodiment, first host 110 and second host 110 reside on the same computer network 100. However, in an alternative embodiment, first host 110 and second host 110 may reside on different computer networks 100.

Persons skilled in the art will understand that policy skins and the use of policy strings to create policy skins are very broad and flexible concepts. Persons skilled in the art therefore will recognize that the descriptions and features set forth herein are included only to elaborate on the present invention and in no way limit the scope of the present invention.

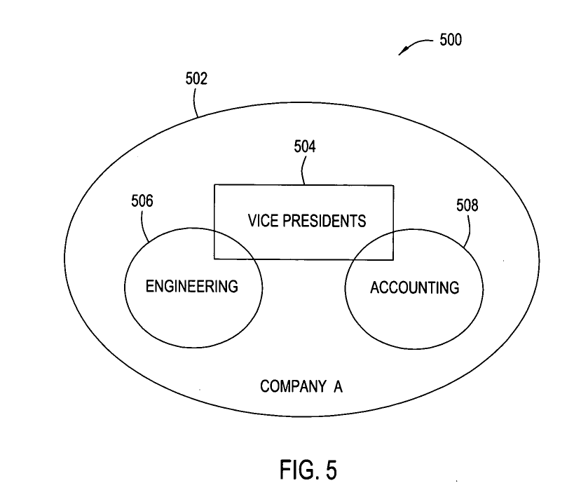

FIG. 5 is a conceptual diagram illustrating a set of groups 500, according to one embodiment of the invention. As shown, set of groups 500 includes, without limitation, a company A group 502, a vice presidents group 504, an engineering group 506 and an accounting group 508. Conceptually, each group represents a specific way of designating one or more hosts 110 of computer network 100. Thus, company A group 502 may include all hosts 110 of computer network 100, meaning that all individual machines within the enterprise, company A, are part of company A group 502. Vice presidents group 504 may include each of hosts 110 registered to a vice president of company A. Engineering group 506 may include each of hosts 110 registered to an engineer of company A. Likewise, accounting group 508 may include each of hosts 110 registered to a member of the accounting department of company A.

A group may be created using any conceivable way of designating one or more hosts 110 of computer network 100. For example, a group may be created for a specific division or department within an enterprise. Engineering group 506 and accounting group 508 are examples of such a group type. A group may be created for certain people within an enterprise such as, for example, a cross-department project team, a group of software developers within the engineering department or a group of senior executives on the executive committee of company A. Vice president group 504 is an example of such a group type. A group may be created using domain names. For example, sub-domains corp.companyA.com and eng.companyA.com may already exist within company A. A group may be designed to include each of hosts 110 belonging to the corp.companyA.com sub-domain, and a group may be designed to include each of hosts 110 belonging to the eng.companyA.com sub-domain. A group also may be created to include each of hosts 110 that receives a specific type of data traffic (packets) or uses a particular set of system files.

One feature of groups is that they can be either static or dynamic. For example, a user may define a group A to include five specific vice presidents. Such a group may be static, meaning that the members of group A do not change unless the user actually redefines group A to include other users. By contrast, a user may define a group B to include all members of the engineering department. Such a group may be dynamic, meaning that group A is automatically updated every time an engineer either leaves or joins the engineering department.

Another feature of groups is that they can be defined based on complying with one or more policy skins. For example, a user may create a policy skin B that contains a policy rule stating that a individual machine implementing policy skin B may communicate only with individual machines that are members of group A. The user may then define a group A to include all hosts 10 that comply with the policy rules set forth in policy skin B. If a first host 110 implements policy skin B, then first host 110 may communicate with a second host 110 only if second host 110 complies with all of the policy rules set forth in policy skin B. Among other things, this type of group structure facilitates secure communications between hosts 10 of different computer networks 100. For example, a policy skin implemented on first hosts 110 of first computer network 100 may require that second hosts 100 of second computer network 100 comply with the policy rules of that policy skin before any of first hosts 100 are allowed to communicate with any of second hosts 100.

One of the purposes of groups is to define the different sets of hosts 110 of computer network 100 that should receive the various policy skins that comprise an enterprise-based security policy. For example, a user may define a group A using IP addresses information stored in host data sub-database 204. The user also may define a policy skin B that the user wants implemented on each of hosts 110 of group A. The user may then designate that group A is to receive policy skin B. As previously described herein, central server 106 may be configured such that central agent 212 retrieves policy skin B from policy sub-database 202 and transmits the executable version of policy skin B to each of hosts 110 in group A. Group information (e.g., which of hosts 110 belongs to group A) may be stored in database 200 of central server 106. In one embodiment, the user may utilize the user interface of central server 106 to access this information the host data stored in host data sub-database 204, to define group A and to designate that group A is to receive policy skin B.

One should note that one or more hosts 100 of computer network 100 may belong to more than one group. A consequence of belonging to more than one group is that one or more hosts 110 may receive more than one policy skin. For example, as shown in FIG. 5, certain hosts 110 belong to both vice president group 504 and engineering group 506. Further, a particular group may receive more than one policy skin. As described above in conjunction with FIG. 4, to the extent that these different policy skins contain conflicting policy rules, the policy rules themselves may be configured to resolve the conflicts.

Similarly to policy skins, persons skilled in the art will understand that groups and the use of policy strings to create groups are very broad and flexible concepts. Persons skilled in the art therefore will recognize that the descriptions and features set forth herein are included only to elaborate on the present invention and in no way limit the scope of the present invention.

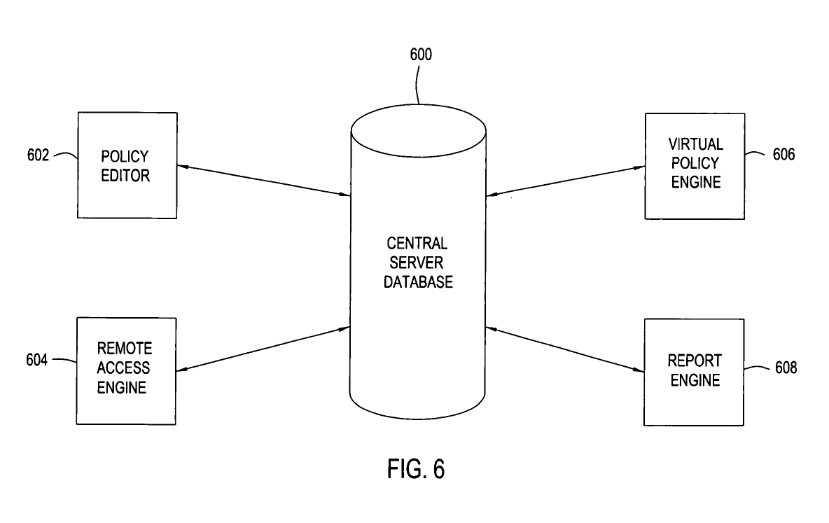

FIG. 6 is a conceptual diagram illustrating various features of the enterprise-based security system, according to one embodiment of the invention. As shown, database 600 of central server 106 may be coupled to various functional engines including, without limitation, a policy editor 602, a remote access engine 604, a virtual policy engine 606 and a report engine 608.

Policy editor 602 is configured to understand the architecture of language stack 300, including policy strings, the PDL and the SDL, as well as the underlying concepts of the disclosed system such as policy skins and groups. Policy editor 602 enables a user to create policy skins and groups using policy strings as well as edit, import and view existing policy skins and groups.

Remote access engine 604 is configured to allow parties located outside of computer network 100 to access central server 106 and database 600. Among other things, remote access engine 604 enables a third party to design, implement, monitor and/or maintain policy skins for one or more users of the disclosed system. For example, a third-party that designs policy skins may use remote access engine 604 to transmit newly-created policy skins to database 600 as well as access information from database 600, such as host data, necessary to create policy skins. Remote access engine 604 also enables a user to access database 600 from outside of computer network 100 for purposes vulnerability and risk analysis and security policy audits and compliance analysis.

Virtual policy engine 606 is configured to enable a user to run a simulation on a given policy skin to test whether and to what extent various hosts 110 of computer network 100 will comply with that policy skin. For example, if the user wants to create and test a new policy skin A for group B, the user may first create policy skin A and then test policy skin A using a shadow copy of existing host data stored in database 600 for each of hosts 110 in group B. More specifically, using virtual policy engine 606, the user may execute policy skin A against the existing host data to determine and analyze the compliance results for each of hosts 110 in group B. Similarly, if a user wants to change part of a policy skin C that is currently being implemented on hosts 100 of group D and determine the ramifications of that change, the user may create a new policy skin C that includes the change and then test the new policy skin C using a shadow copy of existing host data stored in database 600 for each of hosts 110 in group D. Again, using virtual policy engine 606, the user may execute new policy skin C against the existing host data to determine and analyze the compliance results for each of hosts 110 in group D.

Report engine 608 is configured to provide detailed reports regarding the overall state of compliance with the enterprise-based security policy as well as various operational characteristics of hosts 110 and computer network 100 based on the aggregate host data and compliance information for each of hosts 110 stored on database 600. Each report may include, without limitation, policy compliance information for each of hosts 110, security audit results, information pertaining to software bugs found on each of hosts 110 and related fixes, hardware and software inventory information for each of hosts 110 and information pertaining to the amount of bandwidth each of hosts 110 is consuming and the types of data traffic in and out of each of hosts 110. Among other things, reports enable a user to analyze the aggregate level of compliance with an enterprise-based security policy and why various hosts 110 are or are not in compliance with that security policy. In addition, reports enable a user to analyze the individual level of compliance with the policy skins being implemented on each of hosts 110 and why a particular one of hosts 110 is or is not in compliance with those policy skins.

Report engine 608 may be configured to generate reports automatically at any given time interval. For example, reports may be generated automatically either daily, weekly, bi-weekly or monthly. Alternatively, report engine 608 may include an HTML or GUI interface to enable a user to generate reports dynamically at any time. Reports may be generated in any type of output format such as, for example, plain text, HTML, PDF or Crystal Report Writer. Further, reports may be stored in database 600 or transmitted via E-mail or otherwise to select persons within the enterprise. For example, reports may be emailed directly to the network administrator and/or the chief technology officer of the enterprise.

In addition to these aggregate, enterprise-wide reports, each of hosts 110 may be configured to generate individual reports regarding the individual state of compliance of each of hosts 110 as well as various operational characteristics of each of hosts 110.

Persons skilled in the art will understand that the disclosed enterprise-based security system has many functions and features. Persons skilled in the art therefore will recognize that the descriptions and features set forth herein are included only to elaborate on the present invention and in no way limit the scope of the present invention.

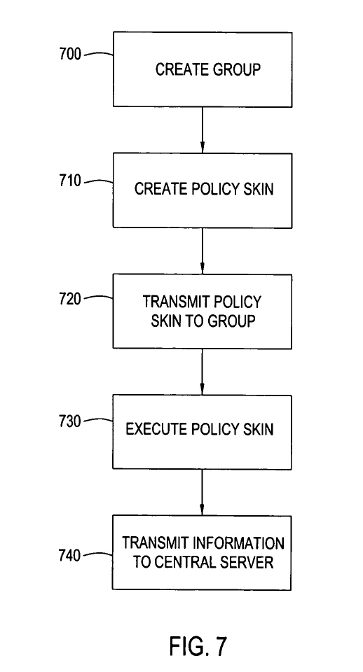

FIG. 7 is a flow chart of method steps for providing an enterprise-based security policy, according to one embodiment of the invention. Although the method steps are described in the context of the systems illustrated in FIGS. 1-6, any system configured to perform the method steps in any order is within the scope of the invention.

The method for providing an enterprise-based security policy starts in step 700 where a user creates a group that comprises one or more hosts 110. In one embodiment, the user creates the group using policy strings. In step 710, the user creates a policy skin. In one embodiment, the policy skin comprises at least one policy rule. In an alternative embodiment, the policy skin also may include at least one other policy skin. In one embodiment, the user creates the policy skin using policy strings. In step 720, the central server 106 transmits the policy skin to each of hosts 110 in the group. In one embodiment, an executable version of the policy skin is transmitted to each of hosts 110 of the group. In an alternative embodiment, the policy string version of the policy skin is transmitted to each of hosts 110 of the group. In step 730, each of hosts 110 executes the policy skin against gathered host data to determine compliance with the security policy (i.e., policy skin). In step 740, each of hosts 110 transmits compliance information as well as gathered host data to central server 106. In one embodiment, this information and data are stored in database 200 and are accessible to remote access engine 604, virtual policy engine 606 and report engine 608 for vulnerability and risk analysis, security policy audits, compliance analysis, policy skin simulations and reports.

One advantage of the system and method described above is that the combination of policy skins and groups enables a user to develop and implement a comprehensive security policy configured to address the specific security needs of all of the different areas of a given enterprise. Another advantage is that policy skins are created using policy strings, which enable users to write security policies in a human-readable format. This capability allows a wide range of users with varying degrees of technical training to create and implement security policies using the disclosed system as individual users do not need to understand the computer code or other syntax underlying the security policies. In addition, policy skins are specially designed for and implemented on the individual machines of a computer network. Policy skins therefore enable an enterprise-based security policy to be tailored to address the specific threats to the individual hosts of an enterprise's computer network. The disclosed system thus focuses security policy compliance and enforcement at the host level-the part of the computer network most susceptible to security threats, as most activity occurs on the individual hosts-thereby resulting in an overall more secure system. Yet another advantage is that the disclosed system provides up-to-date reports setting forth, among other things, the aggregate level of security policy compliance across an enterprise's computer network. These reports, among other things, allow users such as network administrators to understand and to track security policy compliance at each individual machine. This information may be used, for example, to identify and to fix security shortfalls throughout an enterprise's computer network to create an overall more secure system.

The invention has been described above with reference to specific embodiments. Persons skilled in the art, however, will understand that various modifications and changes may be made thereto without departing from the broader spirit and scope of the invention as set forth in the appended claims. For example, in one embodiment, central server 106 is configured to transmit executable versions of security policies to hosts 110. In such an embodiment, translators 304 and 308 reside in central server 106. In an alternative embodiment, central server 106 is configured to transmit policy string versions of security polices to hosts 110. In such an embodiment, translators 304 and 308 reside in each one of hosts 110. In addition, in one embodiment, the functionality of central agent 212, scheduler 218, policy engine 220 and data gathering engine 222 is implemented in software. In alternative embodiments, however, the functionality of each of central agent 212, scheduler 218, policy engine 220 and data gathering engine 222 may be implemented in hardware or a combination of software and hardware. The foregoing description and drawings are, accordingly, to be regarded in an illustrative rather than a restrictive sense.

What is claimed is:

1. A system for providing an enterprise-based security policy, the system comprising:
a central agent configured to retrieve a policy skin from a database and to transmit the policy skin to a host;
a data gathering engine configured to collect host data related to the host; and
a policy engine configured to execute the policy skin against the host data to determine security policy compliance.

2. The system of claim 1, further comprising a host agent configured to transmit the host data and compliance information to the central agent.

3. The system of claim 2, further comprising a scheduler configured to schedule when the data gathering engine collects the host data, when the policy engine executes the security policy and when the host agent transmits the host data and the compliance information to the central agent.

4. The system of claim 2, wherein the central agent is further configured to transmit the host data and the compliance information to the database for storage.

5. The system of claim 4, further comprising a report engine coupled to the database, the report engine configured to access the host data and the compliance information from the database and to generate a report based on the host data and the compliance information.

6. The system of claim 1, wherein a central server includes the central agent, and the host includes the data gathering engine and the policy engine.

7. The system of claim 1, wherein the policy skin when retrieved from the database includes one or more policy strings, and the policy skin when executed includes the one or more policy strings translated into a general purpose language.

8. The system of claim 1, wherein the policy skin when executed is configured to be compatible with an operating system running on the host.

9. The system of claim 1, further comprising a remote access engine coupled to the database, the remote access engine configured to enable a third party to design, implement, monitor or maintain the policy skin.

10. The system of claim 1, further comprising a policy editor coupled to the database, the policy editor configured to enable a user to create the policy skin using policy strings.

11. The system of claim 1, wherein the host is a member of a group.

12. The system of claim 1, wherein the central agent is configured to retrieve a high security level policy skin from the database and to transmit the high security level policy skin to the host in the event of a crisis or emergency.

13. A language stack for providing an enterprise-based security policy, the language stack comprising:
a policy strings layer configured to include policy strings;
a policy definition language layer configured to include a policy definition language;
a first translator configured to parse policy strings into the policy definition language;
a general purpose language layer configured to include a general purpose language; and
a second translator configured to parse the policy definition language into the general purpose language.

14. The language stack of claim 13, wherein the general purpose language comprises Python language.

15. The language stack of claim 13, further comprising a system definition layer configured to include run-time libraries and support services.

16. The language stack of claim 15, wherein an executable version of a policy skin includes one or more policy strings that have been translated into the general purpose language.

17. The language stack of claim 16, wherein the executable version of the policy skin is configured to call one or more run-time libraries or one or more support services from the system definition language when executed.

18. The language stack of claim 16, wherein the executable version of the policy skin is configured to be compatible with an operating system running on a host.

19. A method for providing an enterprise-based security policy, the method comprising:
receiving a policy skin from a central server;
collecting host data related to a host;
executing the policy skin against the host data to determine security policy compliance; and
transmitting the host data and policy compliance information to the central server.

20. The method of claim 19, wherein executing the policy skin comprises calling one or more run-time libraries or one or more support services.

21. The method of claim 19, wherein the policy skin when executed includes one or more policy strings that have been translated into a general purpose language.

22. The method of claim 21, wherein the policy skin when executed is configured to be compatible with an operating system running on the host.

23. The method of claim 19, further comprising the step of creating the policy skin, the policy skin including one or more policy strings.

24. The method of claim 23, wherein a policy editor or a remote access engine is used to create the policy skin.

25. The method of claim 19, further comprising the steps of receiving the host data and compliance information and storing the host data and compliance information in a database.

26. The method of claim 25, wherein the database resides in the central server.

27. The method of claim 25, further comprising the steps of accessing the host data and compliance information from the database and generating a report based on the host data and compliance information.

28. A system for providing an enterprise-based security policy, the system comprising:
means for receiving a policy skin from a central server;
means for collecting host data related to a host;
means for executing the policy skin against the host data to determine security policy compliance; and
means for transmitting the host data and policy compliance information to the central server.

29. The system of claim 28, further comprising means for creating the policy skin, the policy skin including one pr more policy strings.

30. The system of claim 28, further comprising means for receiving the host data and compliance information and means for storing the host data and compliance information in a database.

31. The system of claim 30, further comprising means for accessing the host data and compliance information from the database and means for generating a report based on the host data and compliance information.
